(19) United States
(12) Patent Application Publication
(10) Pub. No.: US 2025/0390877 A1
(43) Pub. Date: Dec. 25, 2025

(54) METHOD AND SYSTEM TO PREVENT FRAUDULENT TRANSACTIONS

(71) Applicant: MASTERCARD INTERNATIONAL INCORPORATED, Purchase, NY (US)

(72) Inventors: Raju Kumar Gupta, Pune (IN); Chetan Kadam, Pune (IN); Ritesh Chaudhari, Pune (IN)

(21) Appl. No.: 18/749,988

(22) Filed: Jun. 21, 2024

(51) Int. Cl. G06Q 20/40; G06Q 20/38; H04M 3/22

(52) U.S. Cl. CPC G06Q 20/4016; G06Q 20/386; H04M 3/2281

(57) ABSTRACT

A method for facilitating prevention of fraudulent transactions is provided. A fraud prevention server extracts content of an ongoing call established with a user device of a user by a caller. The fraud prevention server initiates a communication with a communication device of an acquaintance of the user upon determining that a financial transaction is associated with the call and the caller alleges to be the acquaintance of the user based on the extracted content. The communication indicates the acquaintance to deny or confirm whether the ongoing call with the user device is being set-up by the acquaintance. When a response to the communication indicates denial of the ongoing call being set-up by the acquaintance or in an event of absence of a response to the communication, the fraud prevention server notifies a payment application server to reject the financial transaction associated with the caller.

### FIELD

Various embodiments of the disclosure relate generally to fraud prevention. More specifically, various embodiments of the disclosure relate to methods and systems for facilitating prevention of fraudulent transactions.

### BACKGROUND

Advancements in the field of technology have led to increased traction towards electronic financial transactions. Simultaneously, proliferation of fraudulent activities in electronic financial transactions has increased due to exploitation of highly sophisticated digital manipulation techniques. The exploitation of the manipulation techniques involves the creation of synthetic media that convincingly replace the appearance and voice of one individual with that of another. Perpetrators utilize these deceptive tactics to orchestrate scams, often targeting unsuspecting victims through various communication channels, including video calls and audio calls. In such instances, scammers exploit the trust and familiarity of their targets by impersonating acquaintances or relatives in distressing situations, such as medical emergencies, to acquire funds.

In light of the foregoing, there exists a need for a technical and reliable solution that overcomes the abovementioned problems and facilitates prevention of fraudulent transactions.

### SUMMARY

Methods and systems for facilitating prevention of fraudulent transactions are provided substantially as shown in and described in connection with, at least one of the figures, as set forth more completely in the claims.

In an embodiment of the present disclosure, a method for facilitating prevention of fraudulent transactions is provided. The method comprises extracting by a fraud prevention server, content from an ongoing call established with a first device associated with a first user. The method further comprises identifying by the fraud prevention server, an identifier of a second user associated with the ongoing call based on the content indicating that a financial transaction is associated with the ongoing call. The method further comprises initiating, by the fraud prevention server, a first communication with a second device associated with the identifier. Furthermore, the method comprises instructing a payment application server, by the fraud prevention server, to reject the financial transaction associated with the ongoing call based on one of (i) a first response to the first communication indicating denial of the ongoing call being set-up by the second user and (ii) an absence of the first response to the first communication.

In another embodiment of the present disclosure, a system to facilitate prevention of fraudulent transactions is provided. The system comprises a fraud prevention server that is configured to extract content from an ongoing call established with a first device associated with a first user, and identify based on the content indicating that a financial transaction is associated with the ongoing call, an identifier of a second user associated with the ongoing call. The fraud prevention server is further configured to initiate a first communication with a second device associated with the identifier. Furthermore, the fraud prevention server is configured to instruct a payment application server to reject the financial transaction associated with the ongoing call based on one of (i) a first response to the first communication indicating denial of the ongoing call being set-up by the second user and (ii) an absence of the first response to the first communication.

In some embodiments, the method further comprises parsing, by the fraud prevention server, the content to determine whether the content indicates that the financial transaction is associated with the ongoing call.

In some embodiments, the method further comprises executing upon extracting the content, by the fraud prevention server, a set of deepfake detection models to analyze the content. The method further comprises determining, by the fraud prevention server, based on execution of the set of deepfake detection models, whether the ongoing call is a deepfake call to identify the identifier of the second user.

In some embodiments, the method further comprises training, by the fraud prevention server, the set of deepfake detection models when a second response to the first communication indicates confirmation of the ongoing call being initiated by the second user.

In some embodiments, the method further comprises determining, by the fraud prevention server, based on reception of the ongoing call on the first device, whether contact information of a caller of the ongoing call is absent in a contact list associated with the first user. The content of the ongoing call is extracted upon the determination that the contact information of the caller is absent in the contact list.

In some embodiments, the method further comprises retrieving, by the fraud prevention server, contact information of the second user based on the identifier of the second user from a contact list associated with the first user. The first communication is initiated with the second device based on the contact information. The identifier of the second user is a name of the second user and the contact information of the second user corresponds to at least one of a contact number, a social media username, and an email identifier of the second user.

In some embodiments, the method further comprises setting by the fraud prevention server, a value of a first time period. The method further comprises determining, by the fraud prevention server, whether the first response is received based on the initiation of the first communication with the second device in the first time period. The payment application server is instructed to reject the financial transaction based on the absence of the first response to the first communication at an end of the first time period.

In some embodiments, the method further comprises setting, by the fraud prevention server, a value of a second time period upon setting the value of the first time period, wherein the second time period is shorter than the first time period. The method further comprises generating by the fraud prevention server, a hold request indicating the payment application server to place the financial transaction on hold. The hold request is generated at an end of the second time period and upon the absence of the first response within the second time period.

In some embodiments, the method further comprises receiving, by the fraud prevention server, a second response to the first communication indicating confirmation of the ongoing call being set-up by the second user. The method further comprises transmitting by the fraud prevention server, based on the reception of the second response, a release notification to the payment application server to release the hold on the financial transaction. When the second response is received after the end of the second time period and before the end of the first time period, the release notification is transmitted to the payment application server.

In some embodiments, the method further comprises communicating, by the fraud prevention server, a first notification to the first device based on the first response indicating the denial of the ongoing call being set-up by the second user. The first notification indicates to the first user that the ongoing call is a fraudulent call.

In some embodiments, the content of the ongoing call corresponds to at least one of audio content and video content.

In some embodiments, the first communication corresponds to one of a call, an email, an instant message, a text message, a short message service (SMS), a flash message, and a pop-up notification.

In some embodiments, the fraud prevention server is further configured to parse the content to determine whether the content indicates that the financial transaction is associated with the ongoing call.

In some embodiments, the fraud prevention server further comprises a memory configured to store a set of deepfake detection models, and a processor. The processor is configured to execute, the set of deepfake detection models to analyze the content upon extracting the content. The processor is further configured to determine based on execution of the set of deepfake detection models, that the ongoing call is a deepfake call to identify the identifier of the second user.

In some embodiments, the processor is further configured to train the set of deepfake detection models when the first response to the first communication indicates confirmation of the ongoing call being initiated by the second user.

In some embodiments, the fraud prevention server is further configured to determine based on reception of the ongoing call on the first device, that contact information of a caller of the ongoing call is absent in a contact list associated with the first user. The content of the ongoing call is extracted upon the determination that the contact information of the caller is absent in the contact list.

In some embodiments, the fraud prevention server is further configured to retrieve contact information of the second user based on the identifier of the second user from a contact list associated with the first user. The first communication is initiated with the second device based on the contact information. The identifier of the second user is a name of the second user and the contact information of the second user corresponds to at least one of a contact number, a social media username, and an email of the second user.

In some embodiments, the fraud prevention server is further configured to set a value of a first time period and determine whether the first response is received based on the initiation of the first communication with the second device in the first time period. The payment application server is instructed to reject the financial transaction based on the absence of the first response to the first communication at an end of the first time period.

In some embodiments, the fraud prevention server is further configured to set a value of a second time period upon setting the value of the first time period. The second time period is shorter than the first time period. The fraud prevention server is furthermore configured to generate a hold request indicating the payment application server to place the financial transaction on hold. The financial transaction is placed on hold by the payment application server based on the hold request. The hold request is generated at an end of the second time period and upon the absence of the first response within the second time period.

### BRIEF DESCRIPTION OF THE DRAWINGS

The accompanying drawings illustrate the various embodiments of systems, methods, and other aspects of the disclosure. It will be apparent to a person skilled in the art that the illustrated element boundaries (e.g., boxes, groups of boxes, or other shapes) in the figures represent one example of the boundaries. In some examples, one element may be designed as multiple elements, or multiple elements may be designed as one element. In some examples, an element shown as an internal component of one element may be implemented as an external component in another, and vice versa.

Various embodiments of the present disclosure are illustrated by way of example, and not limited by the appended figures, in which like references indicate similar elements:

FIG. 1 is a block diagram that illustrates a system environment for facilitating prevention of fraudulent transactions, in accordance with an embodiment of the present disclosure;

FIG. 2 illustrates a user interface (UI) screen of a first device of the system environment of FIG. 1 to depict a notification communicated to the first device, in accordance with an embodiment of the present disclosure;

FIGS. 3A-3C illustrate UI screens of a second device of the system environment of FIG. 1 to depict a first communication initiated with the second device, in accordance with an embodiment of the present disclosure;

FIGS. 4A-4E, collectively, represent a process flow diagram that illustrates an exemplary method for facilitating prevention of fraudulent transactions performed by a fraud prevention server of the system environment of FIG. 1, in accordance with an embodiment of the present disclosure;

FIG. 5 is a block diagram that illustrates a system architecture of a computer system of the system environment of FIG. 1, in accordance with an embodiment of the present disclosure;

FIGS. 6A-6D, collectively, represent a flowchart that illustrates a method (i.e., a process) for facilitating prevention of fraudulent transactions by the fraud prevention server, in accordance with an embodiment of the present disclosure; and

FIG. 7 represents a high-level flowchart that illustrates a method for facilitating prevention of fraudulent transactions by the fraud prevention server, in accordance with an embodiment of the present disclosure.

Further areas of applicability of the present disclosure will become apparent from the detailed description provided hereinafter. It should be understood that the detailed description of exemplary embodiments is intended for illustration purposes only and is, therefore, not intended to necessarily limit the scope of the present disclosure.

### DETAILED DESCRIPTION

The present disclosure is best understood with reference to the detailed figures and description set forth herein. Various embodiments are discussed below with reference to the figures. However, those skilled in the art will readily appreciate that the detailed descriptions given herein with respect to the figures are simply for explanatory purposes as the methods and systems may extend beyond the described embodiments. In one example, the teachings presented and the needs of a particular application may yield multiple alternate and suitable approaches to implement the functionality of any detail described herein. Therefore, any approach may extend beyond the particular implementation choices in the following embodiments that are described and shown.

References to “an embodiment”, “another embodiment”, “yet another embodiment”, “one example”, “another example”, “yet another example”, “for example”, and so on, indicate that the embodiment(s) or example(s) so described may include a particular feature, structure, characteristic, property, element, or limitation, but that not every embodiment or example necessarily includes that particular feature, structure, characteristic, property, element or limitation. Furthermore, repeated use of the phrase “in an embodiment” does not necessarily refer to the same embodiment.

### Overview

A user may receive a call from an unknown contact number on a device associated with the user, where the caller claims to be an acquaintance of the user. The caller looks like the acquaintance and/or sounds like the acquaintance during the call. Further, the caller requests the user to perform an urgent financial transaction to a specific account number by fabricating a distressing situation such as a medical emergency or a financial crisis. The user may fall prey to such tactics of the caller as the caller is claiming to be the acquaintance and perform the financial transaction, only to realize later that they have been subjected to a fraud.

Various embodiments of the present disclosure provide a method and a system to resolve the aforementioned problem and prevent fraudulent transactions. The system includes a server (e.g., a fraud prevention server) that extracts content of an ongoing call established with a device associated with the user based on detection that the ongoing call is established by an unknown contact number. Further, the server identifies an identifier of an acquaintance mentioned by the caller of the ongoing call based on the extracted content. A communication is initiated by the server with a device associated with the acquaintance based on the identifier of the acquaintance. The communication indicates the acquaintance to either confirm or deny if the ongoing call with the user is set-up by the acquaintance. In a scenario of the ongoing call being set-up by a fraudulent entity, a response of the acquaintance to the communication indicates denial of the ongoing call being set-up by the acquaintance. The server thus instructs a payment application server associated with the user to reject any financial transactions associated with the ongoing call based on the response indicating the denial to the communication. Further, if the acquaintance is unable to provide the response to the communication in a set time period, the payment application server is further instructed to reject the financial transaction. Thus, the fraudulent financial transaction is prevented.

### Terms Description (in Addition to Plain and Dictionary Meaning)

Content of an ongoing call refers to at least one of audio content and video content involved with the ongoing call. The audio content of the ongoing call includes information conveyed by a caller and a call recipient (i.e., a first user) during the ongoing call. The video content includes video clips of the caller.

An identifier corresponds to a name of a second user where the caller of the ongoing call is claiming to be the second user. The second user may be an acquaintance of the first user.

First communication refers to a call, an email, an instant message, a text message, a short message service (SMS), a flash message, or a pop-up notification that is initiated with a device associated with the second user. The first communication indicates the second user to one of confirm and deny the ongoing call being set-up by the second user.

Financial transaction refers to a process of exchanging funds between two parties using electronic means.

First time period refers to a time period within which a first response to the first communication is desired to be received, a hold request is transmitted to a payment application server in case of absence of the first response to the first communication. The hold request indicates the payment application server to place the financial transaction associated with the ongoing call on hold.

Second time period refers to a time period that begins after the completion of the first time period within which a second response to the first communication is desired to be received. The second time period is shorter than the first time period. The financial transaction associated with the ongoing call is instructed to be rejected upon absence of the second response within the second time period.

Release notification refers to a notification that is transmitted to the payment application server when the second response to the first communication indicates confirmation of the ongoing call being set-up by the second user.

Server is a physical or cloud data processing system on which a server program runs. A server may be implemented in hardware or software, or a combination thereof. In one embodiment, the server is implemented as a computer program that is executed on programmable computers, such as personal computers, laptops, or a network of computer systems. The server may correspond to a fraud prevention server or a payment application server.

Issuer is a financial institution, such as a bank, where accounts of several users are established and maintained. The issuer ensures payment for approved transactions in accordance with various payment network regulations and local legislation.

Deepfake refers to a type of synthetic media that uses artificial intelligence (AI) and machine learning techniques to manipulate or generate audio, images, and videos in a highly realistic manner. The term “deepfake” is derived from “deep learning” and “fake.” Deepfake technology enables the creation of hyper-realistic content by superimposing or replacing one person's likeness with another, often resulting in convincing visual and auditory simulations that can be difficult to distinguish from authentic recordings.

A deepfake detection model refers to a type of artificial intelligence (AI) algorithm designed to identify and classify manipulated or synthesized media. The deepfake detection model typically employs various machine learning and computer vision techniques to analyze the content and determine whether they are likely to be authentic or manipulated.

Contact information corresponds to means that enable communication such as a phone call, a text message, an email, or the like. Contact information may include at least one of a contact number, an email identifier, a social media username, or the like.

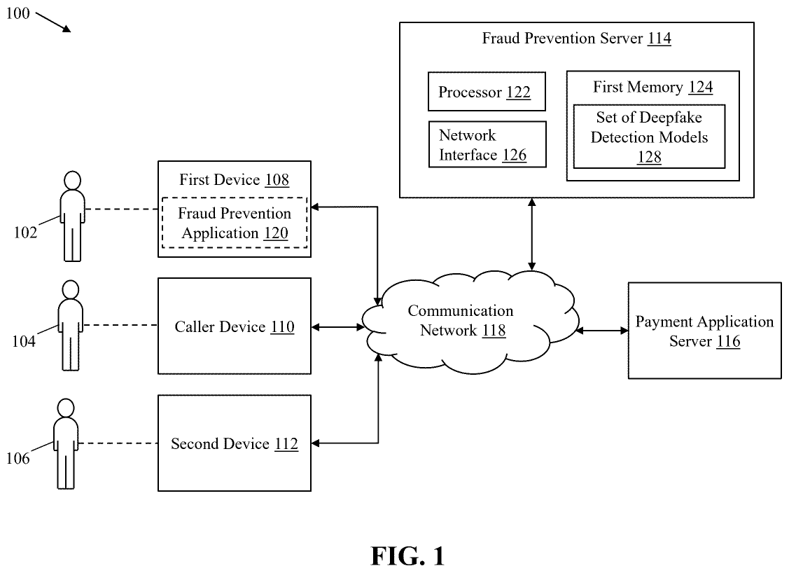

FIG. 1 is a block diagram that illustrates a system environment 100 for facilitating prevention of fraudulent transactions, in accordance with an embodiment of the present disclosure. Particularly, the system environment 100 corresponds to a system for facilitating prevention of fraudulent transactions. The system environment 100 includes a first user 102, a caller 104, a second user 106, a first device 108, a caller device 110, a second device 112, a fraud prevention server 114, a payment application server 116, and a communication network 118. The first device 108, the caller device 110, the second device 112, the fraud prevention server 114, and the payment application server 116 may be coupled to each other by way of the communication network 118.

The first user 102 is an individual associated with a first payment account maintained at a financial institution, such as an issuer. Examples of the first payment account may include a savings account, a current account, a debit account, a credit account, a digital wallet account, or the like.

The first device 108 is a computing device of the first user 102. The first device 108 may be utilized by the first user 102 to communicate with other devices, perform financial transactions, access websites, or the like. Thus, the first device 108 is associated with the first user 102. A payment application provided by the payment application server 116 may be installed on the first device 108. The first user 102 may perform electronic financial transactions by utilizing the payment application. Further, a fraud prevention application 120 provided by the fraud prevention server 114 may be installed on the first device 108. To register the first user 102 on the fraud prevention application 120, the fraud prevention application 120, during the registration, requests the first user 102 for consent to access content of calls received on the first device 108 and a contact list stored on the first device 108. The contact list is a compilation of contact information of a plurality of individuals associated with the first user 102. The plurality of individuals may correspond to one of a relative, a friend, a colleague, or an acquaintance, of the first user 102. In the present embodiment, the plurality of individuals include the second user 106 that owns the second device 112. The contact information of each of the plurality of individuals is mapped against an identifier (e.g., a name) of the corresponding individual in the contact list. The contact information may include at least one of a contact number, an email identifier, a social media username, or the like. The fraud prevention application 120 is configured to detect reception of any call on the first device 108 based on the consent of the first user 102. Further, the fraud prevention application 120 is configured to transmit a first notification to the fraud prevention server 114 upon detection of reception of any call on the first device 108. For the sake of ongoing description, it is assumed that the fraud prevention application 120 detects reception of a call on the first device 108. Further, the fraud prevention application 120 transmits the first notification to the fraud prevention server 114 indicating the reception of the call on the first device 108.

The caller 104 is an individual who initiates the call with the first device 108 by way of the caller device 110 associated with the caller 104. In one scenario, the caller 104 corresponds to one of the plurality of individuals such as the second user 106. Thus, the caller device 110 is the second device 112. The second device 112 of the second user 106 may have a first contact number and a second contact number. The first contact number may be stored in the contact list on the first device 108 whereas the second contact number may be absent from the contact list. In a scenario, the second contact number is utilized to initiate the call by the second device 112 with the first device 108. The second user 106 may use the second contact number to initiate the call in an event of insufficient balance associated with the first contact number, the second user 106 being in an emergency situation, or the like.

In some scenarios, the caller 104 is a scammer who claims to be an acquaintance of the first user 102 during the call. In an example, the caller 104 may use deepfake or generative artificial intelligence (AI) to impersonate one of the plurality of individuals. Particularly, the caller 104 claims to be the second user 106 during the call. Deepfake refers to a type of synthetic media that uses AI and machine learning techniques to manipulate or generate audio, images, and videos in a highly realistic manner. Generative AI is a type of artificial intelligence technology that can produce various types of content, including text, imagery, audio, and synthetic data. The caller 104 sounds and/or looks like the second user 106 during the call by employing deepfake and/or generative AI. Further, the caller 104 may fabricate urgent scenarios, such as medical emergencies or financial crises, to manipulate the first user 102 to perform a financial transaction.

Examples of the first device 108, the caller device 110, and the second device 112 may include, but are not limited to, a mobile phone, a computer, a laptop, a smartphone, a tablet, and a phablet.

The fraud prevention server 114 is a server arrangement that includes suitable logic, circuitry, interface, and/or code executable by the circuitry, for performing various functions to facilitate prevention of fraudulent transactions. The fraud prevention server 114 may be realized through various web-based technologies, such as, but not limited to, a Java web-framework, a .NET framework, a professional hypertext preprocessor (PHP) framework, a python framework, or any other web-application framework. Examples of the fraud prevention server 114 may include, but are not limited to, a personal computer, a laptop, or a network of computer systems. The fraud prevention server 114 includes a processor 122, a first memory 124, and a network interface 126.

The processor 122 of the fraud prevention server 114 includes suitable logic, circuitry, interfaces, and/or code executable by the circuitry for performing various operations to facilitate prevention of fraudulent transactions. The processor 122 is configured to set a value for a first time period while configuring the fraud prevention server 114. Further, the processor 122 is further configured to set a value for a second time period. The second time period is shorter than the first time period. The values for the first time period and the second time period may be set based on an input to the fraud prevention server 114 from an administrator associated with the fraud prevention server 114. The values for the first time period and the second time period may be in milliseconds, seconds, or minutes. In an embodiment, the processor 122 may be configured to extract the contact list from the first device 108 and store the contact list in the first memory 124 upon the registration of the first user 102 on the fraud prevention application 120. Further, the processor 122 may be configured to periodically update the contact list associated with the first user 102 that is stored in the first memory 124. Examples of the processor 122 may include, but are not limited to, an application-specific integrated circuit (ASIC) processor, a reduced instruction set computer (RISC) processor, a complex instruction set computer (CISC) processor, a field programmable gate array (FPGA), a central processing unit (CPU), or the like.

The processor 122 is configured to receive the first notification from the fraud prevention application 120 installed on the first device 108. The first notification indicates the processor 122 that the call has been established between the first device 108 and the caller device 110. The first notification is further indicative of contact information of the caller 104 associated with the call. Hereinafter, the call established between the first device 108 and the caller device 110 may be alternatively referred to as an “ongoing call”. The ongoing call may be at least one of an audio call, a video call, an audio/video call, or the like.

The processor 122 is configured to determine whether the contact information of the caller 104 is absent in the contact list associated with the first user 102 upon receiving the first notification. In one scenario, the contact list stored in the first memory 124 is utilized for the determination. In some scenarios, the contact list stored in the first device 108 is utilized for the determination. In such a scenario, the processor 122 may be configured to transmit a determination request to the first device 108 to determine whether the contact information of the caller 104 is absent in the contact list of the first user 102. The processor 122 may receive a determination response to the determination request that indicates whether the contact information of the caller 104 is absent in the contact list of the first user 102. Further, the processor 122 is configured to extract content from the ongoing call established with the first device 108 associated with the first user 102 based on the determination that the contact information of the caller 104 of the ongoing call is absent in the contact list of the first user 102. The content of an ongoing call refers to at least one of audio content and video content of the ongoing call. The audio content of the ongoing call includes information communicated between the caller 104 and the first user 102 during the ongoing call. The video content includes video clips or image fragments of the ongoing call between the caller 104 and the first user 102.

The processor 122 is configured to parse the content of the ongoing call upon extracting the content to determine whether a financial transaction is associated with the ongoing call. Particularly, the audio content of the ongoing call is parsed. The processor 122 transcribes spoken words from the audio content into text which involves acoustic modeling, language modeling, and speech decoding techniques to recognize and parse spoken languages. The processor 122 may be capable of parsing various languages. The processor 122 is further configured to identify whether the transcribed text includes any terms that are associated with a financial transaction. In an example, the fraud prevention server 114 may include a list that includes a plurality of terms that are associated with a financial transaction. The plurality of terms may include, but are not limited to, ‘transaction’, ‘financial’, ‘money’, ‘account number’, ‘payment’, ‘virtual payment (VPA) ID’, ‘debit card’, ‘digital payment’, ‘online transaction’, ‘bank’, and the like. The processor 122 determines that a financial transaction is associated with the ongoing call based on the identification of at least one term of the plurality of terms in the transcribed text.

The processor 122 is configured to execute a set of deepfake detection models 128 stored in the first memory 124 to analyze the content of the ongoing call upon the determination that the financial transaction is associated with the ongoing call. In other words, the processor 122 provides the content as an input to the set of deepfake detection models 128. The set of deepfake detection models 128 processes the content to determine whether the content is real or fake. Further, the set of deepfake detection models 128 outputs whether the content is real or fake. A deepfake detection model refers to a type of AI algorithm designed to identify and classify manipulated or synthesized media. The deepfake detection model typically employs various machine learning and computer vision techniques to analyze the content and determine whether they are likely to be authentic or manipulated. The set of deepfake detection models 128 may use supervised learning approaches, where the set of deepfake detection models 128 is trained on large datasets of both real and fake media to learn patterns and features that distinguish therebetween. In one embodiment, the processor 122 trains the set of deepfake detection models 128. In another embodiment, the set of deepfake detection models 128 is pre-trained.

The set of deepfake detection models 128 scrutinizes factors such as voice patterns, speech characteristics, inconsistencies in facial expressions, background noises, or the like, all of which are indicative of deepfake manipulation. Further, the set of deepfake detection models 128 outputs whether the content is real or fake. Thus, the processor 122 is configured to determine whether the ongoing call is a deepfake call based on the execution of the set of deepfake detection models 128. In other words, the processor 122 determines whether the ongoing call is a deepfake call based on the output of the set of deepfake detection models 128. In one scenario, the determination that the ongoing call is deepfake based on the execution of the set of deepfake detection models 128 may be true, whereas in another scenario, the determination that the ongoing call is deepfake based on the execution of the set of deepfake detection models 128 may be false due to limitations of training data, complexity of content, or the like. Thus, the processor 122 is configured to perform dual verification to ensure whether the ongoing call is deepfake.

The processor 122 is configured to identify an identifier of the second user 106 who the caller 104 is alleging to be in the ongoing call upon the determination that the ongoing call is a deepfake call. In other words, the processor 122 identifies the identifier of the second user 106 from the parsed content of the ongoing call indicating that a financial transaction is associated with the ongoing call. The financial transaction refers to transfer of funds between the first payment account of the first user 102 and a second payment account of the caller 104. The second payment account may correspond to one of a savings account, a current account, a debit account, a credit account, a digital wallet account, or the like. The identifier is the name of the second user 106. Further, the processor 122 retrieves contact information of the second user 106 from the contact list of the first user 102 based on the identifier of the second user 106. The contact information of the second user 106 may include at least one of the contact number, the social media username, and the email identifier of the second user 106. In an example, the processor 122 may retrieve the contact information of the second user 106 by matching the identifier of the second user 106 with the identifier of each individual of the plurality of individuals in the contact list of the first user 102 to find a match. The processor 122 is further configured to initiate a first communication with the second device 112 associated with the second user 106 based on the contact information of the second user 106 by way of the communication network 118. The first communication indicates the second user 106 to one of confirm and deny the ongoing call with the first device 108 being set-up by the second user 106. The first communication may further indicate the name of the first user 102, a transaction amount requested in the ongoing call, and the account number or the VPA ID disclosed in the ongoing call. The first communication may correspond to one of a call, an email, an instant message, a text message, an SMS, a flash message, and a pop-up notification.

The processor 122 is configured to determine whether a first response to the first communication is received from the second device 112 based on the initiation of the first communication with the second device 112 in the second time period. In an example, the second time period is two minutes. In an embodiment, the processor 122 receives the first response to the first communication in the second time period. In a scenario, when the first response indicates denial of the ongoing call being set-up by the second user 106, the processor 122 is configured to instruct the payment application server 116 to reject the financial transaction associated with the ongoing call. The first response indicating the denial confirms that the ongoing call has been initiated by the caller 104 impersonating the second user 106. The instruction to the payment application server 116 includes at least one of an account number of the caller 104, a VPA ID of the caller 104, and the contact number of the caller 104 and an indication to reject the financial transaction associated therewith. Further, the processor 122 transmits a second notification to the first device 108 of the first user 102 indicating that the ongoing call with the caller 104 is fraudulent to alert the first user 102.

In some scenarios, when the first response indicates confirmation of the ongoing call being set-up by the second user 106, the processor 122 is configured to train the set of deepfake detection models 128 to improve the efficiency of the set of deepfake detection models 128. Thus, the determination that the ongoing call is deepfake by the set of deepfake detection models 128 is proven to be a false detection based on the first response that indicates the confirmation. In such scenarios, the processor 122 labels the extracted content of the ongoing call as real and utilizes the extracted content to train the set of deepfake detection models 128 to improve detection accuracy of the set of deepfake detection models 128. Thus, the present disclosure prevents rejection of a financial transaction with a genuine entity despite of the false positive by the set of deepfake detection models 128.

In some embodiments, the processor 122 is configured to generate a hold request at an end of the second time period and upon the absence of the first response to the first communication within the second time period. The hold request indicates the payment application server 116 to place the financial transaction associated with the ongoing call on hold. The hold request includes at least one of an account number of the caller 104, a VPA ID of the caller 104, and the contact number of the caller 104 and an indication to place the financial transaction associated therewith on hold. The processor 122 transmits the hold request to the payment application server 116 to prevent a potential fraudulent financial transaction with the caller 104. Thus, the financial transaction associated with the ongoing call may be placed on hold by the payment application server 116 based on the hold request.

In one such scenario, the processor 122 is configured to receive a second response to the first communication from the second device 112. The second response is received after the end of the second time period and before the end of the first time period. In an example, the first time period is five minutes and the second time period is two minutes. When the second response indicates confirmation of the ongoing call being set-up by the second user 106, the processor 122 is configured to transmit a release notification to the payment application server 116 to release the hold on the financial transaction associated with the ongoing call. The determination that the ongoing call is deepfake based on the set of deepfake detection models 128 is proven to be false based on the second response that indicates the confirmation. Thus, the release notification is transmitted to the payment application server 116 to release the hold on the financial transaction. Additionally, the processor 122 labels the extracted content of the ongoing call as real and utilizes the extracted content to train the set of deepfake detection models 128 to improve detection accuracy of the set of deepfake detection models 128.

When the second response indicates the denial of the ongoing call being set-up by the second user 106, the processor 122 is configured to instruct the payment application server 116 to reject the financial transaction associated with the ongoing call. Further, the processor 122 is configured to transmit the second notification to the first device 108 of the first user 102 indicating that the ongoing call with the caller 104 is fraudulent to alert the first user 102.

In further embodiments, the processor 122 instructs the payment application server 116 to reject the financial transaction based on an absence of the first response to the first communication at an end of the first time period. In other words, the payment application server 116 is instructed to reject the financial transaction associated with the ongoing call due to absence of response to the first communication within the first time period. Further, the processor 122 transmits the second notification to the first device 108 of the first user 102 indicating that the ongoing call with the caller 104 is fraudulent to alert the first user 102. The second notification may correspond to one of an SMS, a flash message, an instant message, a pop-up notification, an audio alert, a call, or the like.

The processor 122 may generate a training dataset by utilizing the extracted content to train the set of deepfake detection models 128 based on the first response and the second response to improve the efficiency and accuracy of deepfake detection. In an example, the processor 122 may label the extracted content as deepfake when the first response and/or the second response indicates denial of the ongoing call being set-up by the second user 106.

The first memory 124 may be configured to store one or more computer-readable instructions or routines in a non-transitory computer-readable storage medium, which may be fetched and executed by the processor 122 to facilitate prevention of fraudulent transactions. The first memory 124 may be further configured to store the set of deepfake detection models 128. Additionally, the first memory 124 may be configured to store the training dataset generated by the processor 122. The first memory 124 is further configured to store the contact list associated with the first user 102 that is extracted from the first device 108. The first memory 124 is furthermore configured to store the values of the first time period and the second time period set by the processor 122.

The first memory 124 may comprise any non-transitory storage device including, for example, random-access memory (RAM), a read-only memory (ROM), erasable programmable ROM, a hard disk drive (HDD), a flash memory, a solid-state memory, and the like. It will be apparent to a person skilled in the art that the scope of the disclosure is not limited to realizing the first memory 124 in the fraud prevention server 114, as described herein. In another embodiment, the first memory 124 may be realized in form of a database server or a cloud storage working in conjunction with the fraud prevention server 114, without deviating from the scope of the disclosure.

The network interface 126 may comprise a variety of interfaces, for example, interfaces for data input and output devices, referred to as I/O devices, storage devices, and the like. The network interface 126 may facilitate communication of the first device 108, the second device 112, and the payment application server 116 with the fraud prevention server 114 using one or more communication network protocols. The network interface 126 may also provide a communication pathway for one or more components of the fraud prevention server 114. Examples of the network interface 126 may further include, but are not limited to, an antenna, a radio frequency transceiver, a wireless transceiver, a Bluetooth transceiver, an ethernet port, or any other device configured to transmit and receive data.

The payment application server 116 is a server arrangement which includes suitable logic, circuitry, interface, and/or code, executable by the circuitry, for facilitating financial transactions. The payment application server 116 provides the payment application that facilitates the first user 102 to perform the financial transaction by way of the first device 108. The payment application server 116 receives a transaction request from the first device 108 upon initiation of any financial transaction by the first user 102. Further, the payment application server 116 processes the transaction request to facilitate the corresponding financial transaction. The processing of the transaction request includes transfer of funds between an issuer associated with the first user 102 and an acquirer associated with a recipient of the financial transaction. In an embodiment, the functions performed by the payment application server 116 may be performed by a payment network server. A payment network server acts as intermediate entity between acquirer banks and issuer banks to authenticate and fund financial transactions. In such an example, the financial transaction may be initiated by the first user 102 on a website or a banking application associated with the issuer of the first payment account. Examples of a payment network server may include Mastercard®, Visa®, American Express®, or the like. In some embodiments, the functions performed by the payment application server 116 may be performed by a digital payment platform. Examples of the payment application server 116 in such embodiments may include Google Pay®, PayTM®, Apple Pay®, or the like.

In an embodiment, the payment application server 116 receives the instruction from the processor 122 of the fraud prevention server 114 that indicates the payment application server 116 to reject the financial transaction associated with the ongoing call. The first user 102 may have initiated the financial transaction with the caller 104 upon receiving the call from the caller device 110. In such a scenario, the payment application server 116 rejects the financial transaction associated with one of the account number of the caller 104, the VPA ID of the caller 104, and the contact number of the caller 104. The payment application server 116 further ensures that no financial transactions are conducted with the caller 104. In other words, the payment application server 116 may add the account number, the VPA ID, or the contact number of the caller 104 to a black list. In another embodiment, the payment application server 116 receives the hold request from the processor 122. Subsequently, the payment application server 116 places the financial transaction associated with the ongoing call on hold. Further, the payment application server 116 may receive the release notification from the processor 122. The payment application server 116 may release hold on the financial transaction associated with the ongoing call based on the release notification.

The communication network 118 facilitates communication between the first device 108, the caller device 110, the second device 112, the fraud prevention server 114, and the payment application server 116. Examples of the communication network 118 include, but are not limited to, a Wi-Fi network, a light fidelity (Li-Fi) network, a local area network (LAN), a wide area network (WAN), a metropolitan area network (MAN), a satellite network, the Internet, a fiber optic network, a coaxial cable network, an infrared (IR) network, a radio frequency (RF) network, and combinations thereof. Various entities in the system environment 100 may connect to the communication network 118 in accordance with various wired and wireless communication protocols, such as Transmission Control Protocol and Internet Protocol (TCP/IP), User Datagram Protocol (UDP), Long Term Evolution (LTE) communication protocols, or any combination thereof.

Although it is described that the processor 122 of the fraud prevention server 114 performs various operations to prevent fraudulent transactions upon the determination that the ongoing call is deepfake, the scope of the present disclosure is not limited to it. In certain embodiments, the operations performed by the processor 122 upon the determination that the ongoing call is deepfake may be performed upon the determination that the ongoing call is real for dual verification that the ongoing call is real.

In operation, the fraud prevention server 114 sets the values for the first time period and the second time period. The first device 108 of the first user 102 receives the call from the caller device 110. Thus, an ongoing call is established between the first device 108 and the caller device 110. Further, the first device 108 transmits the first notification to the fraud prevention server 114. The first notification indicates the processor 122 of the ongoing call established between the first device 108 and the caller device 110. Particularly, the fraud prevention application 120 installed on the first device 108 detects the reception of the call by the first device 108 and transmits the first notification to the fraud prevention server 114. The first notification further indicates the contact information (e.g., phone number) of the caller 104. The fraud prevention server 114 determines whether the contact information of the caller 104 is absent in the contact list associated with the first user 102. Further, the fraud prevention server 114 extracts the content of the ongoing call based on the determination that the contact information of the caller 104 is absent in the contact list.

The fraud prevention server 114 parses the extracted content to determine whether a financial transaction is associated with the ongoing call. Further, the fraud prevention server 114 executes the set of deepfake detection models 128 to analyze the content based on the determination that the financial transaction is associated with the ongoing call. In other words, the content is provided as an input to the set of deepfake detection models 128. The set of deepfake detection models 128 processes the content to determine whether the content is real or fake. Further, the set of deepfake detection models 128 outputs whether the content is real or fake. The fraud prevention server 114 determines whether the ongoing call is deepfake based on the execution of the set of deepfake detection models 128. The fraud prevention server 114 determines the ongoing call as deepfake when the output of the set of deepfake detection models 128 indicates the content is fake. The fraud prevention server 114 is configured to perform dual verification to confirm if the ongoing call is deepfake when the set of deepfake detection models 128 determines the content as fake.

The fraud prevention server 114 identifies the identifier of the second user 106 from the content based on the determination that the ongoing call is deepfake. In other words, the fraud prevention server 114 identifies the identifier (e.g., name) of the second user 106 from the parsed content. The caller 104 of the ongoing call may be alleging to be the second user 106 in the ongoing call, where the second user 106 is a friend, relative, or an acquaintance of the first user 102. Further, the fraud prevention server 114 retrieves the contact information of the second user 106 from the contact list based on the identifier of the second user 106.

The fraud prevention server 114 initiates the first communication with the second device 112 associated with the identifier of the second user 106. Particularly, the first communication is initiated with the second device 112 associated with the second user 106 based on the contact information of the second user 106. The first communication indicates the second user 106 to confirm or deny whether the ongoing call with the first device 108 of the first user 102 is set-up by the second user 106. In an embodiment, the fraud prevention server 114 may receive the first response to the first communication from the second device 112 before the end of the second time period. Further, the fraud prevention server 114 determines whether the first response to the first communication is received. When the first response indicates the denial of the ongoing call being set-up by the second user 106, the fraud prevention server 114 instructs the payment application server 116 to reject the financial transaction associated with the ongoing call.

The instruction to the payment application server 116 includes at least one of the account number, the VPA ID, and the contact number, of the caller 104 of the ongoing call. Consequently, the payment application server 116 rejects the financial transaction associated with the ongoing call based on the instruction. In other words, the payment application server 116 rejects any transaction that is associated with the first user 102 and the account number, the VPA ID, or the contact number, of the caller 104 of the ongoing call. Additionally, the payment application server 116 may add the account number, the VPA ID, or the contact number of the caller 104 to a black list to prevent any future financial transaction associated therewith. The fraud prevention server 114 communicates the second notification to the first device 108. The second notification indicates the first user 102 that the ongoing call with the caller 104 is fraudulent.

In some scenarios, the fraud prevention server 114 generates the hold request upon absence of the first response to the first communication within the second time period. The hold request indicates the payment application server 116 to place the financial transaction associated with the ongoing call on hold. Further, the fraud prevention server 114 transmits the hold request to the payment application server 116. The payment application server 116 places the financial transaction associated with the ongoing call on hold upon receiving the hold request. Thus, the payment application server 116 places any financial transaction that is associated with the first user 102 and the account number, the VPA ID, or the phone number of the caller 104 of the ongoing call, on hold. In such an embodiment, the fraud prevention server 114 may receive the second response to the first communication after the completion of the second time period and before the completion of the first time period. When the second response indicates the denial of the ongoing call being set up by the second user 106, the fraud prevention server 114 instructs the payment application server 116 to reject the financial transaction associated with the ongoing call. The payment application server 116 rejects the financial transaction that is placed on hold based on the instruction. Further, the fraud prevention server 114 communicates the second notification to the first device 108. The second notification indicates the first user 102 that the ongoing call with the caller 104 is fraudulent. The first user 102 may disconnect the ongoing call with the caller 104 and may further block the contact number of the caller 104 upon receiving the second notification.

When the second response indicates confirmation of the ongoing call being set-up by the second user 106, the processor 122 transmits the release notification to the payment application server 116. The release notification indicates the payment application server 116 to release the hold on the financial transaction associated with the ongoing call. Further, the payment application server 116 releases the hold on the financial transaction associated with the ongoing call based on the release. Thus, the financial transaction associated with the ongoing call may be processed further by the payment application server 116.

In further scenarios, the processor 122 instructs the payment application server 116 to reject the financial transaction associated with the ongoing call upon absence of the second response to the first communication within the first time period. Thus, the payment application server 116 rejects the financial transaction associated with the ongoing call based on the instruction.

In further scenarios, the first response to the first communication that is received within the second time period or the second response to the first communication that is received within the first time period may indicate confirmation of the ongoing call being set-up by the second user 106. In such a scenario, the processor 122 of the fraud prevention server 114 trains the set of deepfake detection models 128. Additionally, in all the above-described embodiments, the processor 122 of the fraud prevention server 114 trains the set of deepfake detection models 128 based on one of the first response, the second response, and absence of any response to the first communication. The set of deepfake detection models 128 is trained to improve the efficiency of deepfake detection.

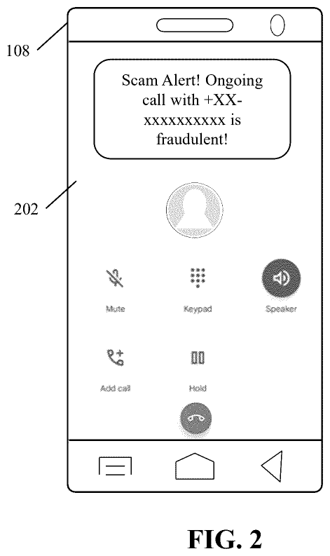

FIG. 2 illustrates a user interface (UI) screen 202 of the first device 108 of the system environment 100 of FIG. 1 to depict the second notification communicated to the first device 108, in accordance with an embodiment of the present disclosure. The second notification illustrated in FIG. 2 corresponds to one of an SMS, a text message, a flash message, an instant message, and a pop-up notification that is displayed on the user interface screen 202 of the first device 108. The second notification indicates “Scam Alert! Ongoing call with +XX-xxxxxxxxxx is fraudulent!”. The second notification is communicated to the first device 108 upon instructing the payment application server 116 to reject the financial transaction associated with the ongoing call. The first user 102 may disconnect the ongoing call with the caller 104 upon receiving the second notification on the first device 108.

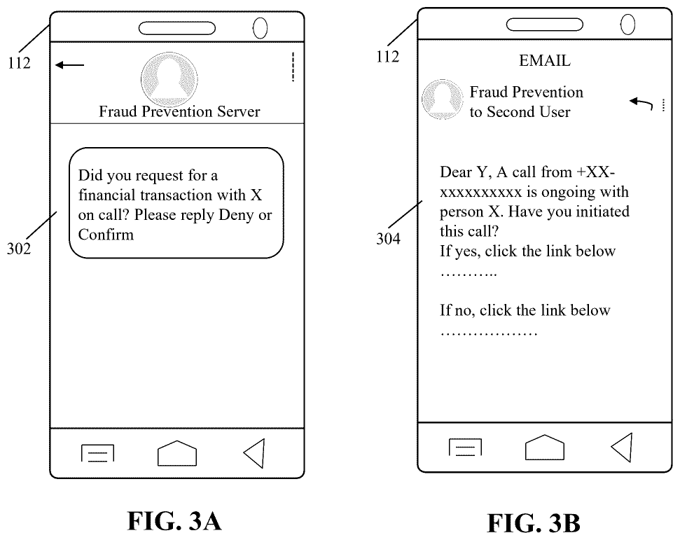

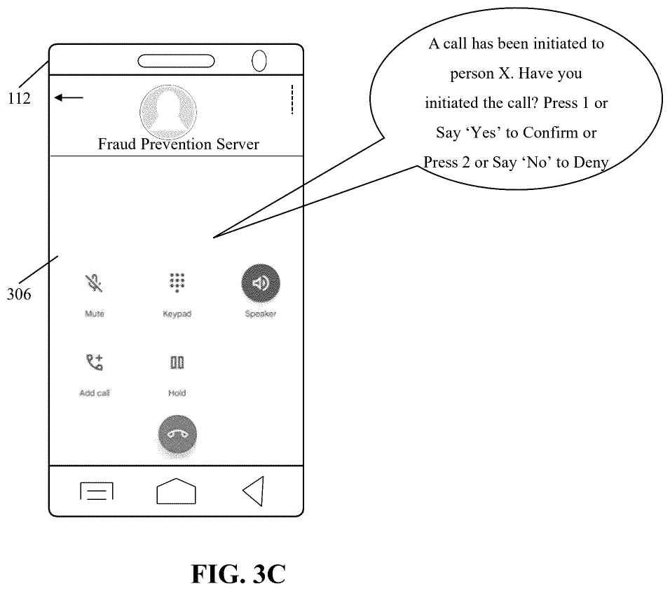

FIGS. 3A-3C illustrate UI screens 302-306 of the second device 112 of the system environment 100 of FIG. 1 to depict the first communication initiated with the second device 112, in accordance with an embodiment of the present disclosure.

Referring to FIG. 3A, the UI screen 302 of the second device 112 is illustrated where the first communication (e.g., a text message, an instant message, an SMS, a flash message, or a pop-up notification) received by the second device 112 is shown. The first communication states “Did you request for a financial transaction with X on call? Please reply Deny or Confirm” X may correspond to the name of the first user 102. The second user 106 may reply either “Confirm” or “Deny” upon receiving the first communication on the second device 112. Further, the first response may indicate denial of the ongoing call being set-up by the second user 106 when the second user 106 replies “Deny” to the first communication. The second response may indicate confirmation of the ongoing call being set-up by the second user 106 when the second user 106 replies “Confirm” to the first communication.

Referring to FIG. 3B, the UI screen 304 of the second device 112 is illustrated where the first communication (e.g., an email) received by the second device 112 is shown. The email states “Dear Y, A call from +XX-xxxxxxxxxx is ongoing with person X. Have you initiated this call?”, the person X may correspond to the name of the first user 102 whereas Y may correspond to the name of the second user 106. The email further provides options “If yes, click the link below . . . If no, click the link below . . . ” to the second user 106.

Further, the first response may indicate denial of the ongoing call being set-up by the second user 106 when the second user 106 clicks the link below associated with “no”. The second response may indicate confirmation of the ongoing call being set-up by the second user 106 when the second user 106 clicks the link below associated with “yes”.

Referring to FIG. 3C, the UI screen 306 of the second device 112 is illustrated where the first communication (e.g., a call) received by the second device 112 in addition to the ongoing call is shown. The call may be an Interactive Voice Response (IVR) call. The call states “A call has been initiated to person X. Have you initiated the call? Press 1 or Say ‘Yes’ to Confirm or Press 2 or Say ‘No’ to Deny”, here the person X corresponds to the name of the first user 102. Further, the first response or the second response is based on a selection of one of the options by the second user 106.

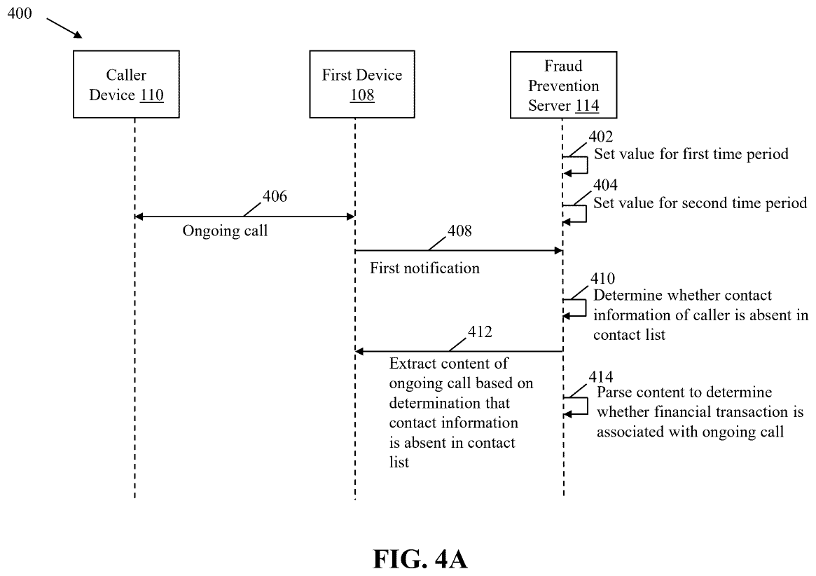

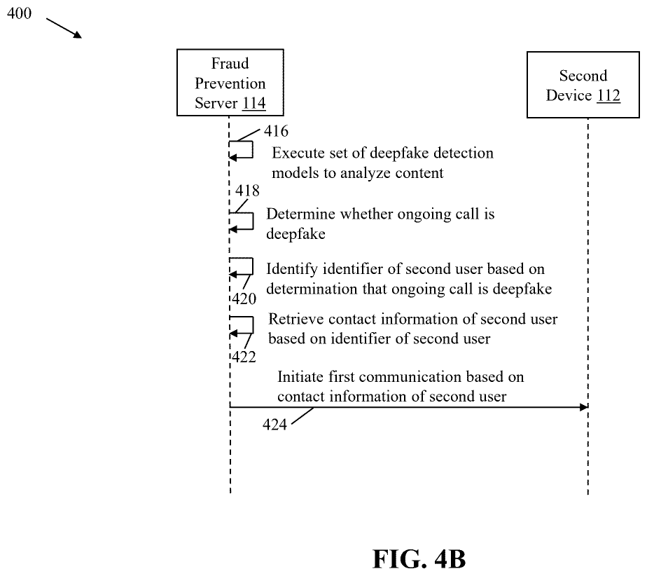

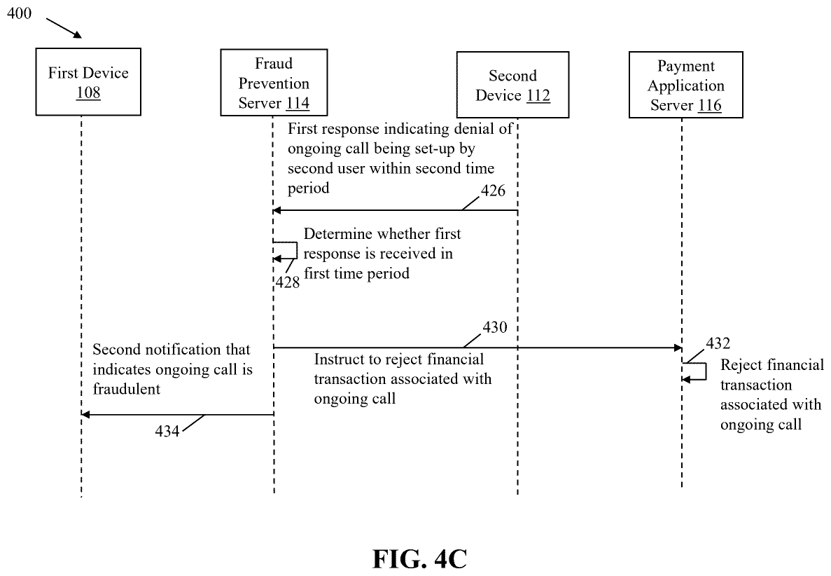

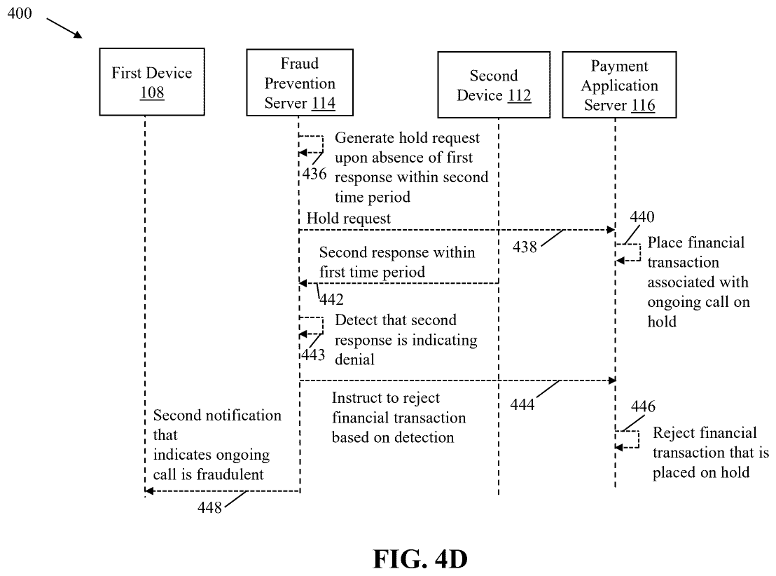

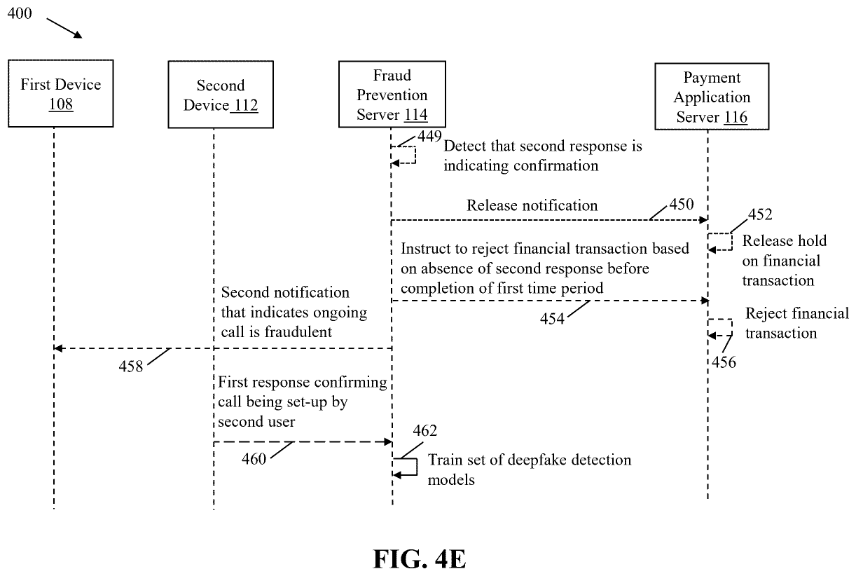

FIGS. 4A-4E, collectively, represent a process flow diagram 400 that illustrates an exemplary method for facilitating prevention of fraudulent transactions performed by the fraud prevention server 114 of the system environment 100 of FIG. 1, in accordance with an embodiment of the present disclosure.

Referring to FIG. 4A, the fraud prevention server 114 sets the value for the first time period (as shown by solid arrow 402). Further, the fraud prevention server 114 sets the value for the second time period (as shown by solid arrow 404). In one embodiment, the values for the first time period and the second time period may be set based on an input to the fraud prevention server 114 from the administrator associated with the fraud prevention server 114. The first device 108 receives the call from the caller device 110. Thus, an ongoing call is established between the first device 108 and the caller device 110 (as shown by solid arrow 406).

The first device 108 transmits the first notification to the fraud prevention server 114 (as shown by solid arrow 408). The first notification indicates the fraud prevention server 114 of the ongoing call between the first device 108 and the caller device 110. Particularly, the fraud prevention application 120 installed on the first device 108 detects the reception of the call by the first device 108 and transmits the first notification to the fraud prevention server 114. The first notification further indicates the contact information (e.g., contact number) of the caller 104. Further, the fraud prevention server 114 determines whether the contact information of the caller 104 is absent in the contact list associated with the first user 102 (as shown by solid arrow 410). Further, the fraud prevention server 114 extracts the content of the ongoing call based on the determination that the contact information of the caller 104 is absent in the contact list associated with the first user 102 (as shown by solid arrow 412).

The fraud prevention server 114 parses the extracted content to determine whether a financial transaction is associated with the ongoing call (as shown by solid arrow 414). In other words, the fraud prevention server 114 parses the content and identifies whether the parsed content includes any terms that are associated with a financial transaction. In an example, the fraud prevention server 114 may include a list that comprises the plurality of terms that are associated with a financial transaction. The plurality of terms may include ‘transaction’, ‘financial’, ‘money’, ‘account number’, ‘payment’, ‘virtual payment ID’, and the like. In such an embodiment, the fraud prevention server 114 identifies whether the parsed content includes at least one term of the plurality of terms. Upon the identification that the parsed content includes at least one term of the plurality of terms, the fraud prevention server 114 determines that a financial transaction is associated with the ongoing call.

Referring to FIG. 4B, the processor 122 executes the set of deepfake detection models 128 to analyze the content based on the determination that the financial transaction is associated with the ongoing call (as shown by solid arrow 416). The set of deepfake detection models 128 receive the content as an input. Further, the set of deepfake detection models 128 processes the content to determine whether the content is real or fake. Consequently, the set of deepfake detection models 128 outputs whether the content is real or fake. The processor 122 determines whether the ongoing call is deepfake based on the execution of the set of deepfake detection models 128 (as shown by solid arrow 418). The processor 122 determines the ongoing call as deepfake when the output of the set of deepfake detection models 128 indicates that the content is fake. The fraud prevention server 114 is further configured to perform dual verification to ensure that the ongoing call is deepfake. The dual verification includes the following operations.

The fraud prevention server 114 identifies the identifier of the second user 106 from the content based on the determination that the ongoing call is deepfake (as shown by solid arrow 420). In other words, the fraud prevention server 114 identifies the identifier (e.g., a name) of the second user 106 from the parsed content. Further, the fraud prevention server 114 retrieves the contact information of the second user 106 from the contact list based on the identifier of the second user 106 (as shown by solid arrow 422). The contact information of the second user 106 may include at least one of the contact number, the social media username, and the email identifier of the second user 106.

The fraud prevention server 114 initiates the first communication with the second device 112 associated with the second user 106 based on the contact information of the second user 106 (as shown by solid arrow 424). The first communication indicates the second user 106 to confirm or deny whether the ongoing call with the first device 108 of the first user 102 is set-up by the second user 106. The first communication may further indicate the name of the first user 102, a transaction amount requested in the ongoing call, and the account number or the VPA ID disclosed in the ongoing call.

Referring to FIG. 4C, in an embodiment, the fraud prevention server 114 may receive the first response indicating denial of the ongoing call being set-up by the second user 106 from the second device 112 within the second time period (as shown by solid arrow 426). Further, the fraud prevention server 114 determines whether the first response to the first communication is received (as shown by solid arrow 428). Further, the fraud prevention server 114 instructs the payment application server 116 to reject the financial transaction associated with the ongoing call (as shown by solid arrow 430). The instruction to the payment application server 116 includes at least one of the account number, the VPA ID, and the phone number of the caller 104 of the ongoing call. Further, the payment application server 116 rejects the financial transaction associated with the ongoing call based on the instruction (as shown by solid arrow 432). Thus, the payment application server 116 rejects any transaction that is associated with the first user 102 and the account number, the VPA ID, or the contact number of the caller 104 of the ongoing call.

The fraud prevention server 114 communicates the second notification that indicates the ongoing call is fraudulent to the first device 108 (as shown by solid arrow 434). The second notification indicates the first user 102 that the ongoing call with the caller 104 is fraudulent.

Referring to FIG. 4D, in some embodiments, the fraud prevention server 114 generates the hold request upon absence of the first response to the first communication within the second time period (as shown by dotted arrow 436). The hold request indicates the payment application server 116 to place the financial transaction associated with the ongoing call on hold. In other words, the hold request indicates the payment application server 116 to place the financial transaction associated with at least one of the account number, the VPA ID, or the contact number of the caller 104 on hold.

The fraud prevention server 114 transmits the hold request to the payment application server 116 (as shown by dotted arrow 438). The payment application server 116 places the financial transaction associated with the ongoing call on hold (as shown by dotted arrow 440). Thus, the payment application server 116 places any transaction that is associated with the first user 102 and the account number, the VPA ID, or the contact number of the caller 104 of the ongoing call, on hold. In such an embodiment, the fraud prevention server 114 may receive the second response to the first communication after the completion of the second time period and within the first time period (as shown by dotted arrow 442). In one scenario, the fraud prevention server 114 detects that the second response indicates the denial of the ongoing call being set up by the second user 106 (as shown by dotted arrow 443). In such a scenario, the fraud prevention server 114 instructs the payment application server 116 to reject the financial transaction associated with the ongoing call based on the detection (as shown by dotted arrow 444). Thus, the fraud prevention server 114 instructs the payment application server 116 to reject the financial transaction that is placed on hold. The payment application server 116 rejects the financial transaction that is placed on hold based on the instruction (as shown by dotted arrow 446). Further, the fraud prevention server 114 communicates the second notification that indicates the first user 102 that the ongoing call with the caller 104 is fraudulent to the first device 108 (as shown by dotted arrow 448).

Referring to FIG. 4E, in another scenario, the fraud prevention server 114 detects that the second response indicates confirmation of the ongoing call being set-up by the second user 106 (as shown by dotted arrow 449). In such a scenario, the fraud prevention server 114 transmits the release notification to the payment application server 116 (as shown by dotted arrow 450). The release notification indicates the payment application server 116 to release the hold on the financial transaction associated with the ongoing call. The payment application server 116 releases the hold on the financial transaction associated with the ongoing call based on the release notification (as shown by dotted arrow 452).

In yet another embodiment, the fraud prevention server 114 instructs the payment application server 116 to reject the financial transaction associated with the ongoing call based on absence of the second response to the first communication before the completion of the first time period (as shown by dash arrow 454). Subsequently, the payment application server 116 rejects the financial transaction associated with the ongoing call based on the instruction (as shown by dash arrow 456). Additionally, the fraud prevention server 114 communicates the second notification that indicates ongoing call is fraudulent to the first device 108 (as shown by dash arrow 458).

In additional embodiments, the first response to the first communication may indicate confirmation of the ongoing call being set-up by the second user 106 (as shown by long dash arrow 460). In all the above described embodiments, the processor 122 trains the set of deepfake detection models 128 based on one of the first response, the second response, and the absence of response to the first communication (as shown by solid arrow 462). The set of deepfake detection models 128 is trained to improve the efficiency of deepfake detection.

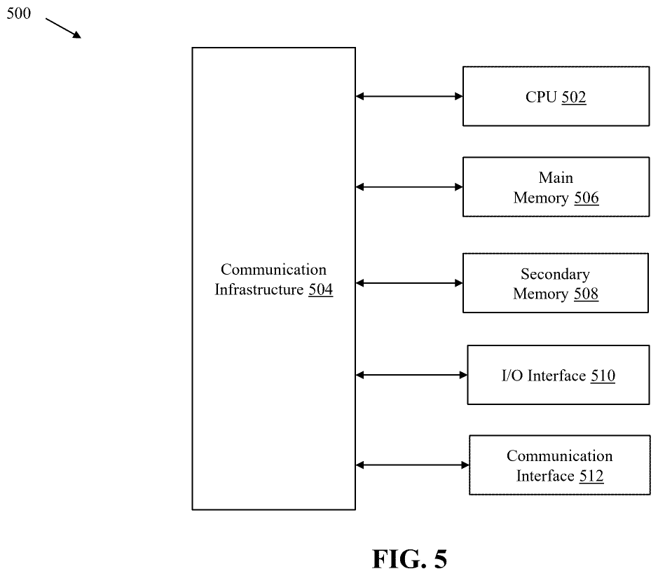

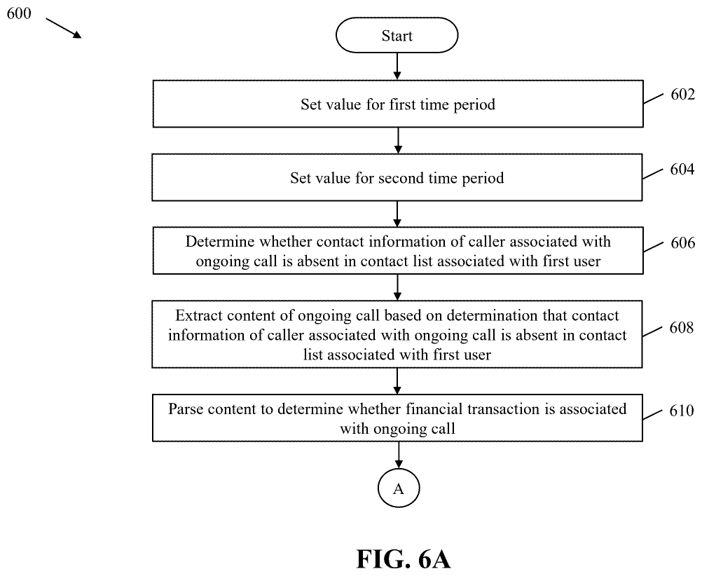

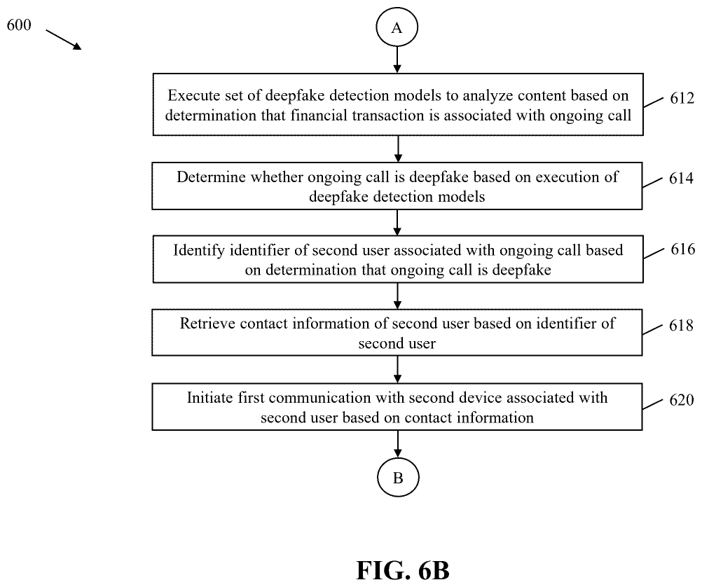

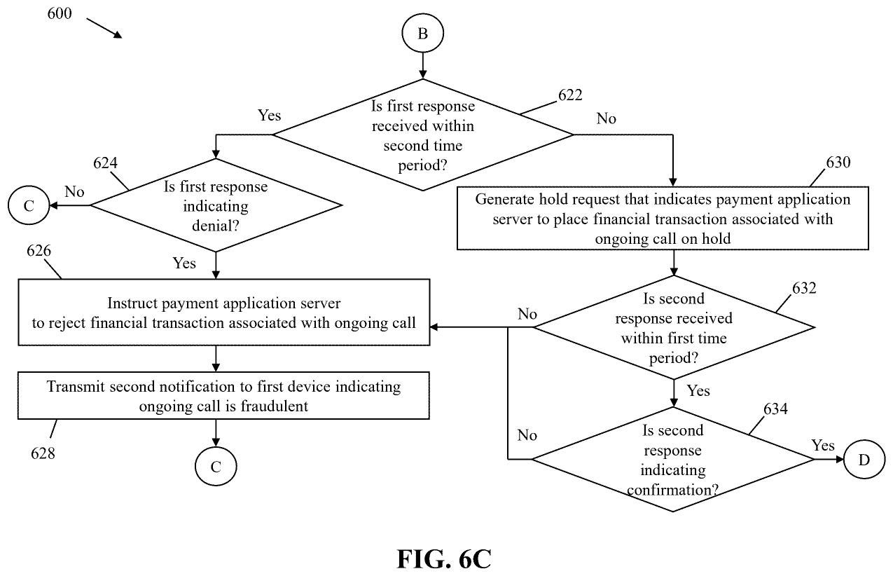

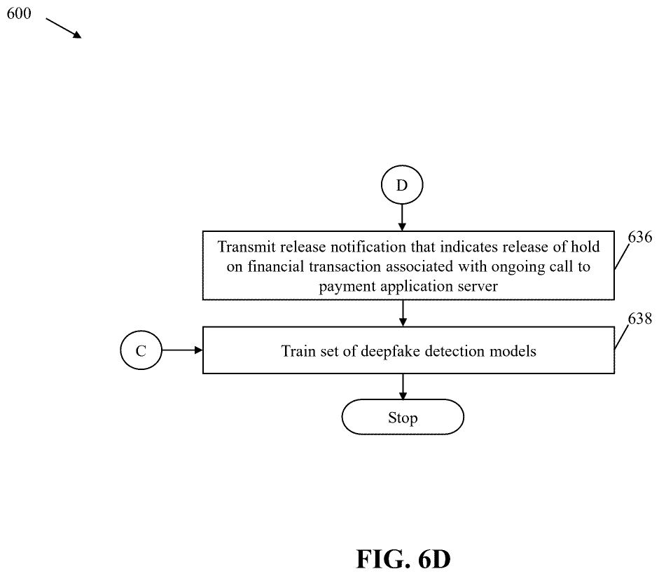

FIG. 5 is a block diagram that illustrates a system architecture of a computer system 500 of the system environment 100 of FIG. 1, in accordance with an embodiment of the present disclosure. An embodiment of present disclosure, or portions thereof, may be implemented as computer readable code on the computer system 500. In one example, the first device 108, the caller device 110, the second device 112, the fraud prevention server 114, and the payment application server 116 may be implemented as the computer system 500. Hardware, software, or any combination thereof may embody modules and components used to implement the methods of FIGS. 6A-6D.

The computer system 500 includes a CPU 502 that may be a special-purpose or a general-purpose processing device. The CPU 502 may be a single processor, multiple processors, or combinations thereof. The CPU 502 may have one or more processor cores. In one example, the CPU 502 is an octa-core processor. Further, the CPU 502 may be connected to a communication infrastructure 504, such as a bus, message queue, multi-core message-passing scheme, and the like. The computer system 500 may further include a main memory 506 and a secondary memory 508. Examples of the main memory 506 may include RAM, ROM, and the like. The secondary memory 508 may include a hard disk drive or a removable storage drive, such as a floppy disk drive, a magnetic tape drive, a compact disc, an optical disk drive, a flash memory, and the like.

The computer system 500 further includes an input/output (I/O) interface 510 and a communication interface 512. The I/O interface 510 includes various input and output devices that are configured to communicate with the CPU 502. Examples of the input devices may include a keyboard, a mouse, a joystick, a touchscreen, a microphone, and the like. Examples of the output devices may include a display screen, a speaker, headphones, and the like. The communication interface 512 may be configured to allow data to be transferred between the computer system 500 and various devices that are communicatively coupled to the computer system 500. Examples of the communication interface 512 may include a modem, a network interface, i.e., an Ethernet card, a communication port, and the like. Data transferred via the communication interface 512 may correspond to signals, such as electronic, electromagnetic, optical, or other signals as will be apparent to a person skilled in the art.

FIGS. 6A-6D, collectively, represent a flowchart 600 that illustrates a method (i.e., a process) for facilitating prevention of fraudulent transactions by the fraud prevention server 114, in accordance with an embodiment of the present disclosure.

Referring to FIG. 6A, at step 602, the value for the first time period is set by the fraud prevention server 114. At step 604, the value for the second time period is set by the fraud prevention server 114 upon setting the value for the first time period. The second time period is shorter than the first time period. The ongoing call is established with the first device 108 of the first user 102 by the caller device 110 of the caller 104. At step 606, it is determined whether the contact information of the caller 104 associated with the ongoing call is absent in the contact list associated with the first user 102 by the fraud prevention server 114 based on the reception of the ongoing call on the first device 108.

At step 608, the content of the ongoing call is extracted by the fraud prevention server 114 based on the determination that the contact information of the caller 104 is absent in the contact list. At step 610, the content is parsed by the fraud prevention server 114 to determine whether a financial transaction is associated with the ongoing call.

Referring to FIG. 6B, at step 612, the set of deepfake detection models 128 is executed by the fraud prevention server 114 to analyze the content based on the determination that the financial transaction is associated with the ongoing call. At step 614, it is determined whether the ongoing call is deepfake by the fraud prevention server 114 based on execution of the set of deepfake detection models 128. At step 616, the identifier of the second user 106 associated with the ongoing call is identified by the fraud prevention server 114 based on the determination that the ongoing call is deepfake.

At step 618, the contact information of the second user 106 is retrieved by the fraud prevention server 114 based on the identifier of the second user 106 from the contact list associated with the first user 102. At step 620, the first communication is initiated with the second device 112 associated with the second user 106 by the fraud prevention server 114 based on the contact information of the second user 106. The first communication indicates the second user 106 to one of confirm and deny whether the ongoing call with the first device 108 is being set-up by the second user 106.

Now referring to FIG. 6C, at step 622, it is determined whether the first response to the first communication is received within the second time period by the fraud prevention server 114. If it is determined that the first response is received within the second time period, the process proceeds to step 624. At step 624, it is determined whether the first response is indicating denial of the ongoing call being set-up by the second user 106 by the fraud prevention server 114. If it is determined that the first response is indicating the denial of the ongoing call being set-up by the second user 106, the process proceeds to step 626. At step 626, the payment application server 116 is instructed by the fraud prevention server 114 to reject the financial transaction associated with the ongoing call. Consequently, the payment application server 116 rejects the financial transaction associated with the ongoing call based on the instruction. At step 628, the second notification to the first device 108 is transmitted by the fraud prevention server 114 indicating that the ongoing call is fraudulent.

At step 622, if absence of the first response to the first communication within the second time period is determined by the fraud prevention server 114, the process proceeds to step 630. At step 630, the hold request that indicates the payment application server 116 to place the financial transaction associated with the ongoing call on hold is generated by the fraud prevention server 114. The payment application server 116, places the financial transaction associated with the ongoing call on hold based on the hold request. At step 632, it is determined whether the second response is received by the fraud prevention server 114 within the first time period. If it is determined that the second response is received within the first time period, the process proceeds to step 634.

At step 634, it is determined whether the second response is indicating confirmation of the ongoing call being set-up by the second user 106 by the fraud prevention server 114. If it is determined that the second response indicates the confirmation, the process proceeds to step 636. Additionally, if absence of the second response to the first communication within the first time period is determined by the fraud prevention server 114 at step 632, the process returns to step 626. If it is determined that the second response is indicating denial of the ongoing call being set-up by the second user 106 at step 634, the process returns to step 626.

Referring to FIG. 6D, at step 636, the release notification that indicates release of hold of the financial transaction associated with the ongoing call is transmitted to the payment application server 116 by the processor 122. At step 638, the set of deepfake detection models 128 is trained by the fraud prevention server 114. The process proceeds to step 638 after the execution of step 628 and upon the determination that the first response is indicating confirmation of the ongoing call being set-up by the second user 106 at step 624.

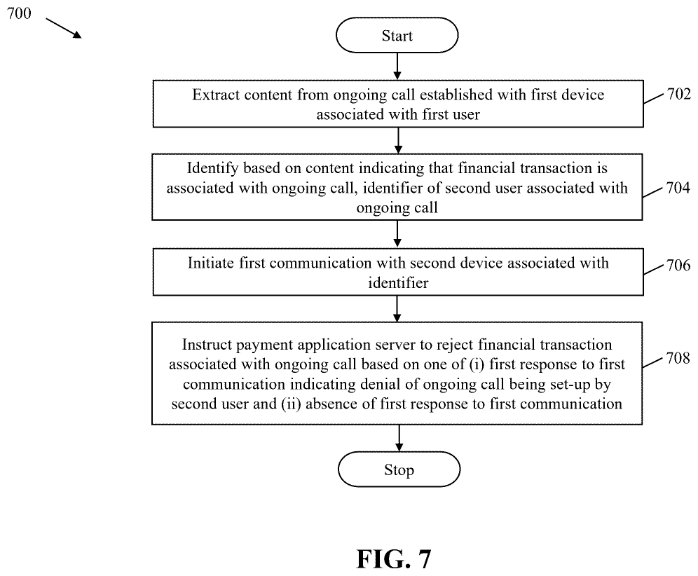

FIG. 7 represents a high-level flowchart 700 that illustrates a method for facilitating prevention of fraudulent transactions by the fraud prevention server 114, in accordance with an embodiment of the present disclosure.

At step 702, content from an ongoing call established with the first device 108 associated with the first user 102 is extracted by the fraud prevention server 114. At step 704, based on the content indicating that the financial transaction is associated with the ongoing call, the identifier of the second user 106 associated with the ongoing call is identified by the fraud prevention server 114. At step 706, the first communication is initiated with the second device 112 associated with the identifier of the second user 106 by the fraud prevention server 114.

At step 708, the payment application server 116 is instructed by the fraud prevention server 114 to reject the financial transaction associated with the ongoing call based on one of (i) the first response to the first communication indicating denial of the ongoing call being set-up by the second user 106 and (ii) an absence of the first response to the first communication.

Embodiments in the disclosure enable the fraud prevention server 114 to facilitate prevention of fraudulent transactions. The fraud prevention server 114 disclosed in the embodiments of the disclosure facilitates a comprehensive approach to thwarting fraudulent transactions that are performed by deceiving a user on a call utilizing deepfake techniques. The fraud prevention server 114 prevents false detection of deepfake by deepfake detection models as the method involves initiating a communication with genuine person to verify whether the call established with the user is fraudulent. Additionally, the second notification indicates the first user 102 that the ongoing call is fraudulent and thus prevents the first user 102 from sharing personal sensitive information with the scammer. The present method prevents chargebacks that are caused due to fraudulent transactions. Also, the method involves training of the set of deepfake detection models 128 to improve the efficiency of the set of deepfake detection models 128. The disclosed method and system that includes the fraud prevention server 114 further increase trust in payment ecosystem by preventing fraudulent transactions.

In the claims, the words ‘comprising’, ‘including’ and ‘having’ do not exclude the presence of other elements or steps then those listed in a claim. The terms “a” or “an,” as used herein, are defined as one or more than one. Unless stated otherwise, terms such as “first” and “second” are used to arbitrarily distinguish between the elements such terms describe. Thus, these terms are not necessarily intended to indicate temporal or other prioritization of such elements. The fact that certain measures are recited in mutually different claims does not indicate that a combination of these measures cannot be used to advantage.

Techniques consistent with the present disclosure provide, among other features, systems and methods for facilitating prevention of fraudulent transactions. While various embodiments of the present disclosure have been illustrated and described, it will be clear that the present disclosure is not limited to these embodiments only. Numerous modifications, changes, variations, substitutions, and equivalents will be apparent to those skilled in the art, without departing from the spirit and scope of the present disclosure, as described in the claims.

What is claimed is:

1. A method for facilitating prevention of fraudulent transactions, the method comprising:
extracting, by a fraud prevention server, content from an ongoing call established with a first device associated with a first user;
identifying based on the content indicating that a financial transaction is associated with the ongoing call, by the fraud prevention server, an identifier of a second user associated with the ongoing call;
initiating, by the fraud prevention server, a first communication with a second device associated with the identifier; and
instructing a payment application server, by the fraud prevention server, to reject the financial transaction associated with the ongoing call based on one of (i) a first response to the first communication indicating denial of the ongoing call being set-up by the second user and (ii) an absence of the first response to the first communication.

2. The method of claim 1, further comprising parsing, by the fraud prevention server, the content to determine whether the content indicates that the financial transaction is associated with the ongoing call.

3. The method of claim 1, further comprising:
executing upon extracting the content, by the fraud prevention server, a set of deepfake detection models associated with the fraud prevention server to analyze the content; and
determining, by the fraud prevention server, based on execution of the set of deepfake detection models, whether the ongoing call is a deepfake call to identify the identifier of the second user.

4. The method of claim 3, further comprising training, by the fraud prevention server, the set of deepfake detection models when a second response to the first communication indicates confirmation of the ongoing call being initiated by the second user.

5. The method of claim 1, further comprising determining, by the fraud prevention server, based on reception of the ongoing call on the first device, whether contact information of a caller of the ongoing call is absent in a contact list associated with the first user, wherein the content of the ongoing call is extracted upon the determination that the contact information of the caller is absent in the contact list.

6. The method of claim 1, further comprising retrieving, by the fraud prevention server, contact information of the second user based on the identifier of the second user from a contact list associated with the first user, wherein the first communication is initiated with the second device based on the contact information, and wherein the identifier of the second user is a name of the second user and the contact information of the second user corresponds to at least one of a contact number, a social media username, and an email identifier of the second user.

7. The method of claim 1, further comprising:
setting by the fraud prevention server, a value of a first time period; and
determining, by the fraud prevention server, whether the first response is received based on the initiation of the first communication with the second device in the first time period, wherein the payment application server is instructed to reject the financial transaction based on the absence of the first response to the first communication at an end of the first time period.

8. The method of claim 7, further comprising:
setting, by the fraud prevention server, a value of a second time period upon setting the value of the first time period, wherein the second time period is shorter than the first time period; and
generating by the fraud prevention server, a hold request indicating the payment application server to place the financial transaction on hold, wherein the financial transaction is placed on hold by the payment application server based on the hold request, and wherein the hold request is generated at an end of the second time period and upon the absence of the first response within the second time period.

9. The method of claim 8, further comprising:
receiving, by the fraud prevention server, a second response to the first communication indicating confirmation of the ongoing call being set-up by the second user; and
transmitting based on the reception of the second response, by the fraud prevention server, a release notification to the payment application server to release the hold on the financial transaction, wherein when the second response is received after the end of the second time period and before the end of the first time period, the release notification is transmitted to the payment application server.

10. The method of claim 1, further comprising communicating, by the fraud prevention server, a first notification to the first device based on the first response indicating the denial of the ongoing call being set-up by the second user, wherein the first notification indicates to the first user that the ongoing call is a fraudulent call.

11. The method of claim 1, wherein the content of the ongoing call corresponds to at least one of audio content and video content.

12. The method of claim 1, wherein the first communication corresponds to one of a call, an email, an instant message, a text message, a short message service (SMS), a flash message, and a pop-up notification.

13. A system for facilitating prevention of fraudulent transactions, comprising:
a fraud prevention server configured to:
extract content from an ongoing call established with a first device associated with a first user;
identify based on the content indicating that a financial transaction is associated with the ongoing call, an identifier of a second user associated with the ongoing call;
initiate a first communication with a second device associated with the identifier; and
instruct a payment application server to reject the financial transaction associated with the ongoing call based on one of (i) a first response to the first communication indicating denial of the ongoing call being set-up by the second user and (ii) an absence of the first response to the first communication.

14. The system of claim 13, wherein the fraud prevention server is further configured to parse the content to determine whether the content indicates that the financial transaction is associated with the ongoing call.

15. The system of claim 13, wherein the fraud prevention server further comprises:
a memory configured to store a set of deepfake detection models; and
a processor configured to:
execute, the set of deepfake detection models to analyze the content upon extracting the content; and
determine based on execution of the set of deepfake detection models, whether the ongoing call is a deepfake call to identify the identifier of the second user.

16. The system of claim 15, wherein the processor is further configured to train the set of deepfake detection models when the first response to the first communication indicates confirmation of the ongoing call being initiated by the second user.

17. The system of claim 13, wherein the fraud prevention server is further configured to determine based on reception of the ongoing call on the first device, that contact information of a caller of the ongoing call is absent in a contact list associated with the first user, wherein the content of the ongoing call is extracted upon the determination that the contact information of the caller is absent in the contact list.

18. The system of claim 13, wherein the fraud prevention server is further configured to retrieve contact information of the second user based on the identifier of the second user from a contact list associated with the first user, wherein the first communication is initiated with the second device based on the contact information, and wherein the identifier of the second user is a name of the second user and the contact information of the second user corresponds to at least one of a contact number, a social media username, and an email of the second user.

19. The system of claim 13, wherein the fraud prevention server is further configured to:
set a value of a first time period; and
determine whether the first response is received based on the initiation of the first communication with the second device in the first time period, wherein the payment application server is instructed to reject the financial transaction based on the absence of the first response to the first communication at an end of the first time period.

20. The system of claim 19, wherein the fraud prevention server is further configured to:
set a value of a second time period upon setting the value of the first time period, wherein the second time period is shorter than the first time period; and
generate a hold request indicating the payment application server to place the financial transaction on hold, wherein the financial transaction is placed on hold by the payment application server based on the hold request, and wherein the hold request is generated at an end of the second time period and upon the absence of the first response within the second time period.
